(19) United States
(12) Patent Application Publication
(10) Pub. No.: US 2024/0098581 A1
(43) Pub. Date: Mar. 21, 2024

(54) METHOD AND APPARATUS FOR OPTIMIZING EPS FALLBACK IN NEXT GENERATION MOBILE COMMUNICATION

(71) Applicant: Samsung Electronics Co., Ltd., Gyeonggi-do (KR)

(72) Inventor: Sangbum KIM, Gyeonggi-do (KR)

(21) Appl. No.: 18/468,350

(22) Filed: Sep. 15, 2023

(30) Foreign Application Priority Data
Sep. 21, 2022 (KR) 10-2022-0119371

(51) Int. Cl. H04W 36/00; H04W 76/20

(52) U.S. Cl. CPC H04W 36/00226; H04W 36/0058; H04W 36/0079; H04W 76/20

(57) ABSTRACT

The disclosure relates to a 5G or 6G communication system for supporting higher data rates. The disclosure discloses a method and an apparatus capable of optimizing early EPS fallback. A method performed by a terminal in a wireless communication system includes receiving, from a base station of a first RAT, a message to command an inter-RAT HO, the message including information indicating that the inter-RAT HO is triggered by EPS fallback for IMS voice; performing the inter-RAT HO based on the message; based on a failure of the inter-RAT HO, identifying whether there is a suitable cell of a second RAT for selection; in case that there is no suitable cell of the second RAT, selecting an acceptable cell of the second RAT based on the IMS voice being for an emergency service; and logging a time until the terminal accesses the acceptable cell of the second RAT.

### CROSS-REFERENCE TO RELATED APPLICATION(S)

This application is based on and claims priority under 35 U.S.C. § 119 to Korean Patent Application No. 10-2022-0119371, which was filed in the Korean Intellectual Property Office on Sep. 21, 2022, the entire disclosure of which is incorporated herein by reference.

### BACKGROUND

### 1. Field

The disclosure relates generally to a method and an apparatus for optimizing early evolved packet system (EPS) fallback.

### 2. Description of Related Art

5^{th} generation (5G) mobile communication technologies define broad frequency bands such that high transmission rates and new services are possible, and can be implemented in “sub 6 GHz” bands such as 3.5 GHz, and also in “above 6 GHz” bands, which may be referred to as mmWave, including 28 GHz and 39 GHz. In addition, it has been considered to implement 6th generation (6G) mobile communication technologies (referred to as beyond 5G systems) in terahertz bands (e.g., 95 GHz to 3 THz bands) in order to accomplish transmission rates fifty times faster than 5G mobile communication technologies and ultra-low latencies one-tenth of 5G.

Since the initial state of 5G mobile communication technologies, in order to support services and satisfy performance requirements in connection with enhanced mobile broadband, (eMBB), ultra reliable & low latency communications (URLLC), and massive machine-type communications (mMTC), there has been ongoing standardization regarding beamforming and massive multiple input, multiple output (MIMO) for alleviating radio-wave path loss and increasing radio-wave transmission distances in mmWave, numerology (e.g., operating multiple subcarrier spacings) for efficiently utilizing mmWave resources and dynamic operation of slot formats, initial access technologies for supporting multi-beam transmission and broadbands, definition and operation of a bandwidth part (BWP), new channel coding methods such as a low density parity check (LDPC) code for large-capacity data transmission and a polar code for highly reliable transmission of control information, layer 2 (L2) pre-processing, and network slicing for providing a dedicated network customized to a specific service.

Currently, there discussion regarding improvement and performance enhancement of initial 5G mobile communication technologies in view of services to be supported by newer 5G mobile communication technologies, including physical layer standardization regarding technologies such as vehicle to everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is a UE-satellite direct communication for securing coverage in an area in which communication with terrestrial networks is impossible, and positioning.

There is also ongoing standardization in wireless interface architecture/protocol fields regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including a conditional handover (HO) and a dual active protocol stack (DAPS) HO, and two-step random access for simplifying random access procedures (2-step RACH for NR).

There is also ongoing standardization in system architecture/service fields regarding a 5G baseline architecture (e.g., service based architecture or service based interface) for combining network functions virtualization (NFV) and software-defined networking (SDN) technologies, and mobile edge computing (MEC) for receiving services based on UE positions.

AS newer 5G mobile communication systems are commercialized, the number of devices that will be connected to communication networks is expected to exponentially increase, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), etc. (XR=AR+VR+MR), 5G performance improvement and complexity reduction by utilizing artificial intelligence (AI) and machine learning (ML), AI service support, metaverse service support, and drone communication.

Furthermore, such development of 5G mobile communication systems will serve as a basis for developing new waveforms for securing coverage in THz bands of 6G mobile communication technologies, full dimensional MIMO (FD-MIMO), multi-antenna transmission technologies such as array antennas and large-scale antennas, metamaterial-based lenses and antennas for improving coverage of terahertz band signals, high-dimensional space multiplexing technology using orbital angular momentum (OAM), and reconfigurable intelligent surface (RIS), and also as a basis for developing full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

A next generation mobile communication system may support a voice fallback operation. For example, voice fallback may include an EPS fallback operation which, in case that a terminal connected to an NR base station requests Internet protocol (IP) multimedia subsystem (IMS) voice services, causes the terminal to be connected to a long term evolution (LTE) network that supports IMS voice services in order to provide IMS voice services to the terminal. In case that the EPS fallback operation is performed, an early EPS fallback operation may be configured to shorten a required time while avoiding delays due to measurement configuration and reporting required for the operation.

### SUMMARY

The disclosure is provided to address at least the above-mentioned problems and/or disadvantages and to provide at least the advantages described below.

An aspect of the disclosure is to provide a method for optimizing early EPS fallback.

Another aspect of the disclosure is to provide a method and an apparatus in which a terminal collects early EPS fallback-related information and reports the collected information to a base station.

Another aspect of the disclosure is to provide a method and an apparatus in which early EPS fallback-related information collected by a terminal and reported to a base station is forwarded from the base station to another base station or transmitted to a server, to be used for EPS fallback optimization.

In accordance with an aspect of the disclosure, a method performed by a terminal is provided. The method includes receiving, from a base station of a first radio access technology (RAT), a message to command an inter-RAT HO, the message including information indicating that the inter-RAT HO is triggered by EPS fallback for IMS voice, performing the inter-RAT HO based on the message, identifying whether there is a suitable cell of a second RAT for selection, based on a failure of the inter-RAT HO, in case that there is no suitable cell of the second RAT, selecting an acceptable cell of the second RAT based on the IMS voice being for an emergency service, and logging a time until the terminal accesses to the acceptable cell of the second RAT.

In accordance with another aspect of the disclosure, a terminal is provided, which includes a transceiver, and a controller configured to control the transceiver to receive, from a base station of a first RAT, a message to command an inter-RAT HO, the message including information indicating that the inter-RAT HO is triggered by EPS fallback for IMS voice, perform the inter-RAT HO based on the message, identify whether there is a suitable cell of a second RAT for selection, based on a failure of the inter-RAT HO, in case that there is no suitable cell of the second RAT, select an acceptable cell of the second RAT based on the IMS voice being for an emergency service, and log a time until the terminal accesses to the acceptable cell of the second RAT.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a next-generation mobile communication system according to an embodiment;

FIG. 2A is a signal flow diagram illustrating a procedure for indicating voice fallback according to an embodiment;

FIG. 2B is a signal flow diagram illustrating a procedure for indicating voice fallback according to an embodiment;

FIG. 3 illustrates an operation for recording voice fallback-related information in an inter-RAT HO according to an embodiment;

FIG. 4A is a signal flow diagram illustrating an early measurement reporting (EMR) process according to an embodiment;

FIG. 4B is a signal flow diagram illustrating an EMR process according to an embodiment;

FIG. 5A is a signal flow diagram illustrating an existing EPS fallback and an early EPS fallback process according to an embodiment;

FIG. 5B is a signal flow diagram illustrating an existing EPS fallback and an early EPS fallback process according to an embodiment;

FIG. 6 is a signal flow diagram illustrating a process of storing early EPS fallback-related information as radio link failure (RLF) report contents according to an embodiment;

FIG. 7 is a flowchart illustrating a UE operation of storing early EPS fallback-related information as RLF report contents according to an embodiment;

FIG. 8 is a signal flow diagram illustrating a process of storing early EPS fallback-related information as successful HO report (SHR) contents according to an embodiment;

FIG. 9 is a flowchart illustrating a UE operation of storing early EPS fallback-related information as SHR report contents according to an embodiment;

FIG. 10 is a signal flow diagram illustrating a process of storing early EPS fallback-related information as connection establishment failure (CEF) report contents according to an embodiment;

FIG. 11 is a flowchart illustrating a UE operation of storing early EPS fallback-related information as CEF report contents according to an embodiment;

FIG. 12 is a signal flow diagram illustrating a process of storing fallback-related information for emergency services as RLF report contents according to an embodiment;

FIG. 13 is a flowchart illustrating a UE operation of storing fallback-related information for emergency services as RLF report contents according to an embodiment;

FIG. 14 illustrates a terminal according to an embodiment; and

FIG. 15 illustrates a base station according to an embodiment.

### DETAILED DESCRIPTION

Hereinafter, various embodiments of the disclosure will be described in detail in conjunction with the accompanying drawings. In the following description of the disclosure, detailed descriptions of known functions or configurations incorporated herein will be omitted when it is determined that the descriptions may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims.

Throughout the specification, the same or like reference numerals may designate the same or like elements.

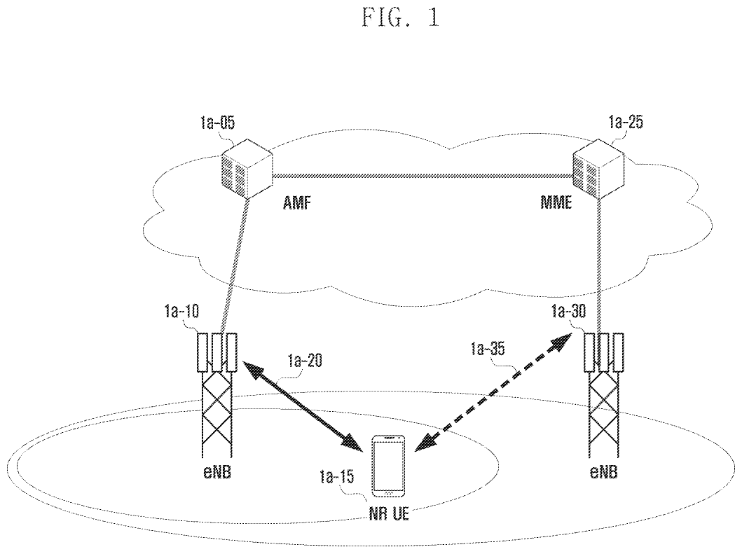

FIG. 1 illustrates a next generation mobile communication system according to an embodiment.

Referring to FIG. 1, a radio access network of a next generation mobile communication system (e.g., an NR communication system) includes a next generation base station (e.g., a new radio node B (gNB)) 1a-10 and an access and mobility management function (AMF) 1a-05 (e.g., an NR core network (CN)). A user terminal (e.g., an NR UE or terminal) 1a-15 is connected to an external network through the gNB 1a-10 and the AMF 1a-05.

In FIG. 1, the gNB 1a-10 corresponds to an evolved node B (eNB) of the existing LTE system. The gNB 1a-10 is connected to the NR UE 1a-15 via a radio channel, and may provide services superior to that of the existing Node B (indicated by reference numeral 1a-20).

In the next-generation mobile communication system, since all user traffic is served via a shared channel, a device for performing scheduling by collecting state information, such as the buffer state of the UEs, available transmission power state, and channel state, is required, and the gNB 1a-10 is in charge thereof. One gNB usually controls multiple cells.

In order to realize ultra-high speed data transmission, compared to the existing LTE, more than the existing maximum bandwidth may be provided, and orthogonal frequency-division multiplexing (OFDM) as a RAT may be additionally combined with beamforming technology. In addition, an adaptive modulation and coding (AMC) method for determining the modulation scheme and the channel-coding rate according to the channel condition of a terminal is applied.

The AMF 1a-05 performs functions such as mobility support, bearer configuration, and quality of service (QoS) configuration. The AMF 1a-05 is a device that is responsible for various control functions as well as mobility management functions for a terminal, and is connected to multiple base stations.

In addition, the next-generation mobile communication system may be linked with an existing LTE system, and the AMF 1a-05 may be connected to a mobility management entity (MME) 1a-25 through a network interface. The MME 1a-25 is connected to the existing base station eNB 1a-30. The terminal 1a-15 supporting LTE-NR dual connectivity may transmit and receive data, while maintaining a connection to the eNB 1a-20 as well as the gNB 1a-30 (indicated by reference numeral 1a-35).

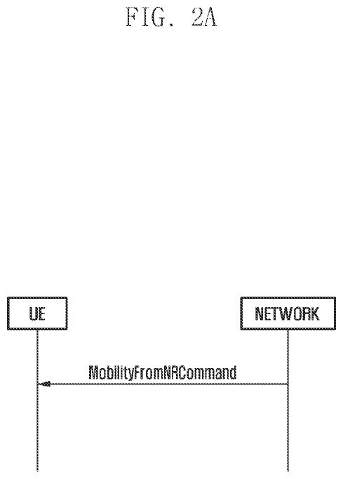

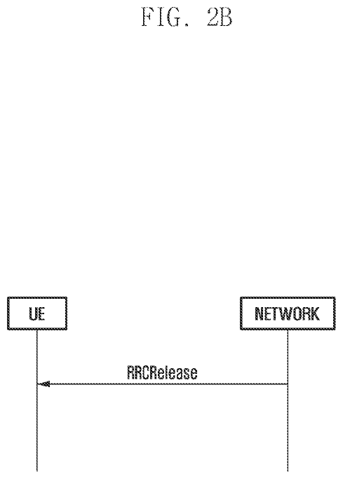

FIG. 2A is a signal flow diagram illustrating a procedure for indicating voice fallback according to an embodiment, and FIG. 2B is a signal flow diagram illustrating a procedure for indicating voice fallback according to an embodiment.

Herein, voice fallback refers to EPS fallback which, in order to provide IMS voice services to a terminal connected to an NR network, causes the terminal to be connected to an LTE network supporting IMS voice services. When a higher network instructs an NR base station that the EPS fallback is required for a terminal, the NR base station triggers an inter-RAT HO or re-direction to allow the terminal to be connected to an LTE base station. In the inter-RAT HO or re-direction operation, the NR base station may indicate that the operation is for voice fallback, allowing the terminal to fulfill requirements corresponding thereto or make the necessary preparations accordingly.

Referring to FIG. 2A, the NR base station (i.e., the Network) transmits a MobilityFromNRCommand message that includes configuration information for the inter-RAT HO to the terminal (i.e., the UE), and the MobilityFromNRCommand message includes a voiceFallbackIndication, which is an indicator indicating that the operation is for voice fallback.

Referring to FIG. 2B, for re-direction, the NR base station (i.e., the Network) transmits_a radio resource control (RRC) release (RRCRelease) message to the terminal (i.e., the UE) including configuration information for re-direction, and the RRCRelease message includes a voiceFallbackIndication, which is an indicator of voice fallback.

In accordance with an embodiment of the disclosure, to optimize a voice fallback operation, a method is provided in which a terminal records and reports information related thereto. The recorded information may be reported to a network via an RLF report, a CEF report, and/or a successful HO report.

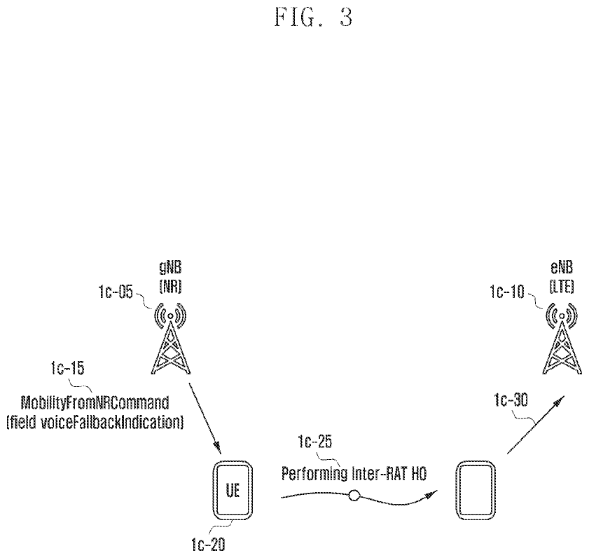

FIG. 3 illustrates an operation of recording voice fallback-related information in an inter-RAT HO according to an embodiment.

Referring to FIG. 3, a UE 1c-20 receives a MobilityFromNRCommand message 1c-15 including a voiceFallbackIndication from a base station 1c-05, and when a predetermined condition is satisfied, the UE 1c-20 records predetermined information 1c-25. The recorded information is reported from the UE 1c-20 to the base station 1c-10 through a predetermined procedure. In order to reduce the time required for EPS fallback, EMR results reported by the terminal to the base station may be utilized. In accordance with an embodiment of the disclosure, when EPS fallback is performed using EMR, information related thereto is stored.

EMR is a technique in which, after a UE switches to a connected mode, the UE reports latest cell measurement information collected in a standby mode (e.g., RRC_IDLE) or inactive mode (e.g., RRC_INACTIVE) to a base station as soon as possible.

When the UE is to be provided with a data transmission service at a high data transmission rate, the base station first configures, for the UE, a neighboring cell measurement operation and measurement result reporting. Based on the cell measurement results reported by the terminal, the base station may select a suitable cell that can provide sufficient signal strength, and configure the cell as a secondary cell (SCell). Therefore, the operation of configuring an SCell may be somewhat delayed due to the process of cell measurement configuration and reporting. To solve the delay, the base station may configure the EMR for the terminal.

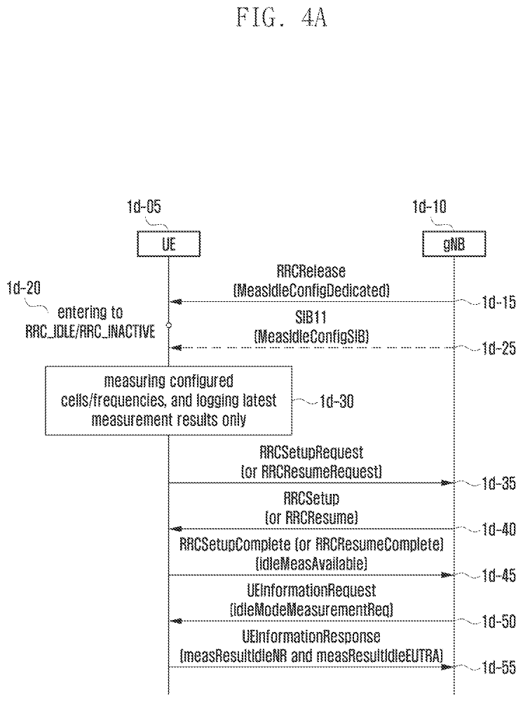

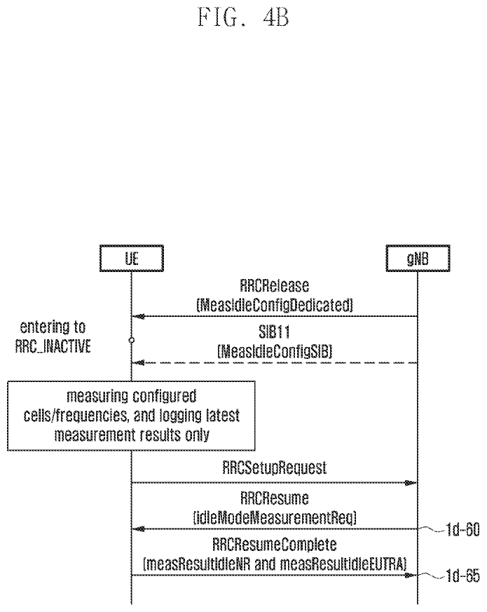

FIG. 4A is a signal flow diagram illustrating an EMR process according to an embodiment, and FIG. 4B is a signal flow diagram illustrating an EMR process according to an embodiment.

Referring to FIG. 4A, in step 1d-15, a base station 1d-10 transmits an RRCRelease message including a MeasIdleConfigDedicated information element (IE) to the UE 1d-05. The IE includes information for performing an EMR operation.

Upon receiving the RRCRelease message, in step 1d-20, the UE 1d-05 switches from the connected mode to a standby or inactive mode (e.g., RRC_IDLE or RRC_INACTIVE).

In step 1d-25, the UE 1d-05 may also receive a system information block (SIB) including a MeasIdleConfigSIB IE. The MeasIdleConfigDedicated IE may include information on NR frequencies or evolved universal mobile telecommunication system (UMTS) terrestrial radio access (EUTRA) frequencies that the UE 1d-05 should measure and record for EMR. If the frequency information is not included, the UE 1d-05 considers the NR frequency information or the EUTRA frequency information included in the MeasIdleConfigSIB IE.

In step 1d-30, the UE 1d-05 measures preconfigured NR frequencies or EUTRA frequencies by using EMR configuration information, and stores the most recent measurement result. The UE 1d-05 may store up to eight frequency measurement results for each NR and EUTRA.

To switch to a connected mode, the UE 1d-05 transmits an RRCSetupRequest message or an RRCResumeRequest message to the base station in step 1d-35.

Upon receiving the message, the base station 1d-10 transmits an RRC Setup message or an RRCResume message to the UE 1d-05 in step 1d-40. The UE 1d-05 transmits an RRCSetupComplete message or an RRCResumeComplete message including a predetermined availability indicator or an idleMeasAvailable field to the base station 1d-10 in step 1d-45. The field is used to indicate that the UE 1d-05 has EMR measurement results.

In step 1d-50, the base station 1d-10 may include a predefined field for requesting the reporting of the measurement results or an idleModeMeasurementReq in a UEInformationRequest message and transmit the message to the UE 1d-05.

Upon receiving the message, the UE 1d-05 transmits a UEInformationResponse message including the EMR measurement results to the base station 1d-10 in step 1d-55.

Referring to FIG. 4B, in case that the UE 1d-05 switches from the inactive mode to the connected mode, the base station 1d-10 may transmit an RRCResume message including the idleModeMeasurementReq field to the UE 1d-05 in step 1d-60. The UE 1d-05 receiving the message may report an RRCResumeComplete message including the EMR measurement results to the base station 1d-10 in step 1d-65, which allows the reporting of the measurement results to the base station to be performed faster than the method of using a UE information process.

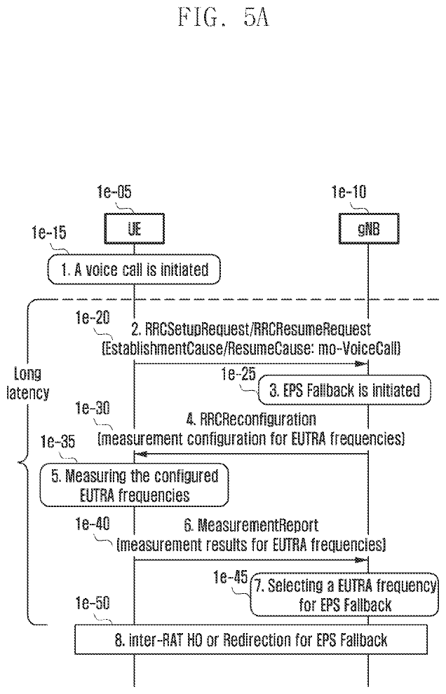

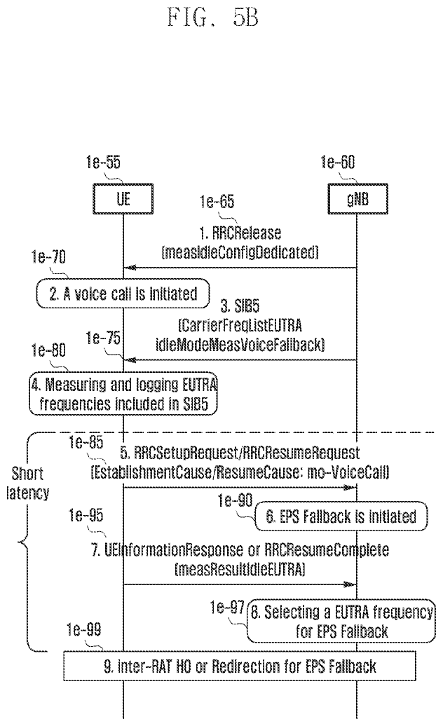

FIG. 5A is a signal flow diagram illustrating existing EPS fallback and early EPS fallback process according to an embodiment, and FIG. 5B is a signal flow diagram illustrating existing EPS fallback and early EPS fallback process according to an embodiment.

Referring to FIG. 5A, a UE 1e-05, which is camping-on an NR base station (e.g., gNB) 1e-10, requests IMS voice service from the NR base station 1e-10 in step 1e-15. To this end, the UE 1e-05 transmits an RRCSetupRequest message or an RRCResumeRequest message including a predetermined cause value, “mo-VoiceCall”, indicating the IMS voice service request to the base station 1e-10 in step 1e-20.

Upon receiving the message, the base station 1e-10 triggers an EPS fallback operation in step 1e-25. The EPS fallback is an operation in which the NR base station hands over a terminal requiring IMS voice services to an EUTRA base station, allowing the terminal to receive the service. The NR base station 1e-10 may trigger the EPS fallback because a function for providing IMS service is not yet implemented, or for the purpose of load balancing even when the function for providing IMS service has been implemented.

To perform the above EPS fallback, the NR base station 1e-10 first configures, for the UE 1e-05, to measure a signal for neighboring EUTRA frequencies and report a result of the measurement in step 1e-30. According to the cell measurement configuration information, the UE 1e-05 measures the configured EUTRA frequencies in step 1e-35. The UE 1e-05 transmits a MeasurementReport message including the measurement result to the NR base station 1e-10 in step 1e-40.

Upon receiving the message, the base station 1e-10 selects one EUTRA frequency suitable for EPS fallback based on the cell measurement result stored in the message in step 1e-45. The NR base station 1e-10 configures, for the UE 1e-05, an inter-RAT HO to the EUTRA frequencies or re-direction operation to the EUTRA frequencies in step 1e-50.

Similar to the above-mentioned cause of delay in the configuration of SCell, the above-described process of configuration and reporting of cell measurements may be a delay factor in performing the EPS fallback. Therefore, in order to improve the delay, the above EMR operation can be utilized.

Referring to FIG. 5B, a base station (e.g., gNB) 1e-60 transmits an RRCRelease message including a MeasIdleConfigDedicated IE to a UE 1e-55 in step 1e-65. The IE includes information for performing an EMR operation.

Upon receiving the RRCRelease message, the UE 1e-55 switches from a connected mode to a standby or inactive mode. The UE 1e-55 triggers IMS voice services in step 1e-70.

Further, the UE 1e-55 identifies whether an idleModeMeasVoiceFallback field is included in SIB 5 in step 1e-75. If the field is included in SIB 5, the UE 1e-55 that triggered IMS voice services may also consider EUTRA frequencies for the purpose of cell reselection, included in SIB 5, as frequencies to be stored through the EMR operation in step 1e-80.

The UE 1e-55 transmits an RRCSetupRequest message or an RRCResumeRequest message including a predetermined cause value, “mo-VoiceCall”, indicating the IMS voice service request to the base station 1e-60 in step 1e-85.

Upon receiving the message, the base station 1e-60 may trigger the EPS fallback operation in step 1e-90.

The EUTRA frequency measurement results for performing the EPS fallback are transmitted to the base station 1e-60 through a UEInformationResponse message or an RRCResumeComplete message, in the same manner as for the EMR operation, in step 1e-95.

Upon receiving the message, the base station 1e-60 selects one EUTRA frequency suitable for EPS fallback based on the cell measurement results included in the message in step 1e-97. In addition, the base station 1e-60 configures, for the UE 1e-55, an inter-RAT HO to the EUTRA frequencies or a re-direction operation to the EUTRA frequencies in step 1e-99. The EUTRA frequency measurement results provided by SIBS for the purpose of cell reselection may also be reported to the base station through a conventional EMR operation, thereby reducing the time required for EPS fallback. Herein, the EPS fallback operation utilizing the above EMR measurement results is referred to as early EPS fallback.

In order to optimize early EPS fallback, a method is provided for collecting early EPS fallback-related information by a terminal and reporting the collected information to a base station. New information related to early EPS fallback is stored in an existing RLF report, an SHR, and a CEF report when predetermined conditions are satisfied.

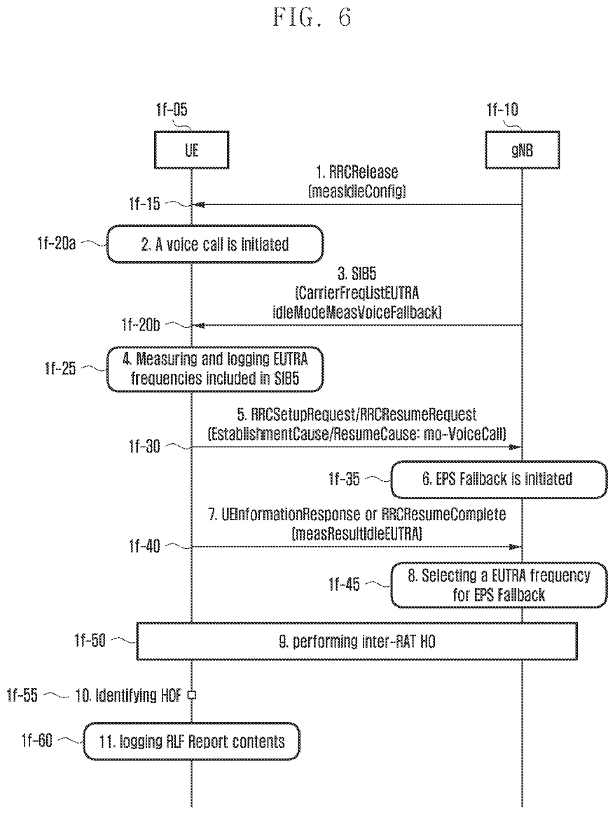

FIG. 6 is a signal flow diagram illustrating a process of storing early EPS fallback-related information as RLF report contents according to an embodiment.

Referring to FIG. 6, a base station 1f-10 transmits an RRCRelease message including a MeasIdleConfigDedicated IE to a UE 1f-05 in step 1f-15. The IE includes information for performing an EMR operation.

Upon receiving the RRCRelease message, the UE 1f-05 switches from a connected mode to a standby or inactive mode and triggers IMS voice services in step 1f-20a. The UE 1f-05 identifies whether an idleModeMeasVoiceFallback field is included in SIB 5 in step 1f-20b. If the field is included in SIB 5, the UE 1f-05 that triggered IMS voice services may also consider EUTRA frequencies for the purpose of cell reselection, included in SIB 5 as frequencies to be stored through the EMR operation in step 1f-25.

The UE 1f-05 transmits an RRCSetupRequest message or an RRCResumeRequest message including a predetermined cause value, “mo-VoiceCall”, indicating the idleModeMeasVoiceFallback field, to the base station 1f-10 in step 1f-30.

Upon receiving the message, the base station 1f-10 may trigger the EPS fallback operation in step 1f-35.

The EUTRA frequency measurement results for performing the EPS fallback are stored in the MeasResultIdleEUTRA IE and transmitted to the base station 1f-10 through a UEInformationResponse message or an RRCResumeComplete message including the IE in step 1f-40.

Upon receiving the message, the base station 1f-10 selects one EUTRA frequency suitable for EPS fallback based on the cell measurement results stored in the message in step 1f-45. The base station 1f-10 may configure, for the UE 1f-05, an inter-RAT HO to the EUTRA frequencies in step 1f-50. To trigger the inter-RAT HO, the base station 1f-10 transmits a MobilityFromNRCommand message including configuration information for performing the inter-RAT HO to the UE 1f-05. In this case, the message includes a voiceFallbackIndication field.

Upon receiving the message, the UE 1f-05 starts a T304 timer, and when the inter-RAT HO has not been successfully completed until the timer expires (i.e., random access process to a target cell has not been successfully completed), the UE considers that the HO has failed (i.e., HO failure (HOF)), in step 1f-55. The UE 1f-05 may store predetermined information related to the failure of the HO as RLF report contents in step 1f-60.

When at least one of conditions A and B is satisfied, the information related to the early EPS fallback may be stored in the VarRLF-Report along with the information related to the previously-defined HO failure.
A—The UE 1f-05 has reported the measurement result of EUTRA frequencies configured in SIB 5 to a serving base station (or serving cell) that transmitted the MobilityFromNRCommand through an EMR operation, and the inter-RAT HO triggered by the MobilityFromNRCommand has failed, or
B—The UE 1f-05 has performed an inter-RAT HO to one of the EUTRA cells belonging to the EUTRA frequencies configured in SIBS, which have been reported through the EMR operation, and the HO has failed.

The information related to the early EPS fallback may include the following.
An indicator indicating whether a UE has reported the measurement results of the EUTRA frequencies configured in SIB 5 to a base station by using EMR.
An indicator indicating whether an idleModeMeasVoiceFallback field is configured in SIB 5 that a serving cell is broadcasting.
An indicator indicating whether a cell belonging to the EUTRA frequencies configured in SIB 5 corresponds to a target cell in the inter-RAT HO.
An indicator indicating whether a cell belonging to the EUTRA frequencies configured in SIB 5 and reported through EMR corresponds to a target cell in the inter-RAT HO.
A list of EUTRA frequencies configured in SIB 5 and reported through EMR and information related to frequencies, i.e., absolute radio frequency channel number (ARFCN) information for each frequency, physical cell identity (PCI) information for cells belonging to each frequency, and reference signal received power (RSRP)/reference signal received quality (RSRQ) measurement results.
   Information about the time taken after a UE transmits an RRCSetupRequest/RRCResumeRequest message (or after receiving an RRCSetup/RRCResume message) for obtaining IMS services and until the UE receives a MobilityFromNRCommand message.
   Information about the time until the inter-RAT HO fails after a UE transmits an RRCSetupRequest/RRCResumeRequest message for receiving IMS services.
   Information about the time taken after EMR measurement information is reported through a UEInformationResponse message or an RRCResumeComplete message and until a MobilityFromNRCommand message is received.
   Information about the time until the inter-RAT HO fails after reporting EMR measurement information through a UEInformationResponse message or an RRCResumeComplete message.

When the UE 1f-05 is connected to the base station 1f-10, the UE transmits a predetermined RRC message including a predetermined availability indicator to the base station 1f-10. The availability indicator is used to indicate that the RLF report contents are being stored. Upon receiving the indicator, the base station 1f-05 may request the stored RLF report by using a UEInformationRequest message. Upon receiving the request, the UE 1f-05 reports a UEInformationResponse message including the RLF report to the base station 1f-10.

Upon receiving the RLF report, the base station 1f-10 forwards the RLF report to other base stations relevant to the information contained in the RLF report, or transmits the RLF report to a predetermined implementation server, e.g., a self-organized network (SON) server. The information may be used to optimize the EPS fallback.

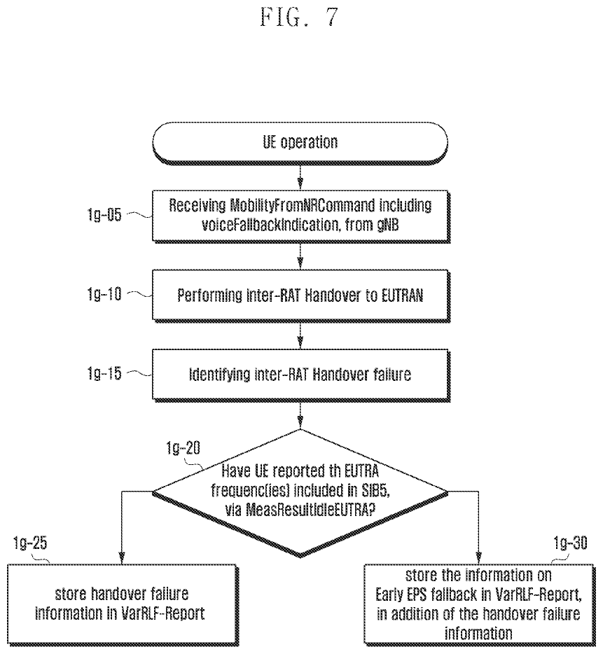

FIG. 7 is a flowchart illustrating a UE operation of storing early EPS fallback-related information as RLF report contents according to an embodiment.

Referring to FIG. 7, in step 1g-05, the UE receives a MobilityFromNRCommand message including a voiceFallbackIndication field from a base station.

In step 1g-10, the UE performs inter-RAT HO by using the inter-RAT HO configuration information included in the MobilityFromNRCommand. Here, the T304 timer is driven.

In step 1g-15, the UE identifies an inter-RAT HO failure. For example, the UE determines that the inter-RAT HO has failed 1f the T304 timer expires before the inter-RAT HO has been successfully completed.

In step 1g-20, the UE determines whether EUTRA frequency information stored in SIB 5 has been reported to the base station through an EMR process before performing the inter-RAT HO for EPS fallback.

In step 1g-25, 1f the EUTRA frequency information stored in SIB 5 has not reported to the base station through the EMR process, the UE stores previously-defined HO failure-related information in VarRLF-Report, which is a UE internal storage variable.

In step 1g-30, 1f the EUTRA frequency information stored in SIBS has been reported to the base station through the EMR process, the UE stores the new information in accordance with this embodiment, together with the previously-defined HO failure-related information, in the VarRLF-Report, which is the UE internal storage variable.

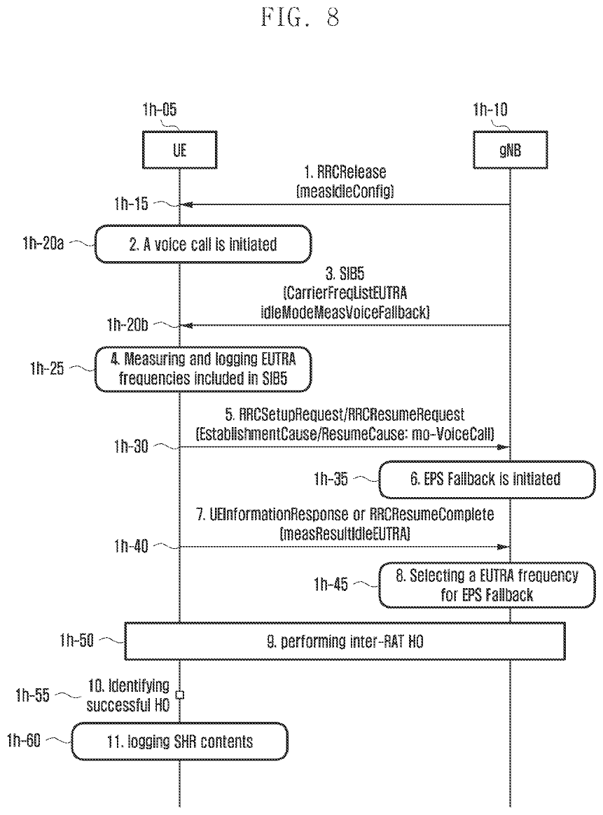

FIG. 8 is a signal flow diagram illustrating a process of storing early EPS fallback-related information as SHR contents according to an embodiment.

Referring to FIG. 8, a base station 1h-10 transmits an RRCRelease message including a MeasIdleConfigDedicated IE to a UE 1h-05 in step 1h-15. The IE includes information for performing an EMR operation.

Upon receiving the RRCRelease message, the UE 1h-05 switches from a connected mode to a standby or inactive mode, and triggers IMS voice services in step 1h-20a. The UE 1h-05 identifies whether an idleModeMeasVoiceFallback field is included in SIB 5 in step 1h-20b. If the field is included in SIB 5, the UE 1h-05 that triggered IMS voice services may also consider EUTRA frequencies for the purpose of cell reselection, included in SIB 5, as frequencies to be stored through the EMR operation in step 1h-25.

The UE 1h-05 transmits an RRCSetupRequest message or an RRCResumeRequest message including a predetermined cause value, “mo-VoiceCall”, indicating the idleModeMeasVoiceFallback field to the base station 1h-10 in step 1h-30.

Upon receiving the message, the base station 1h-10 may trigger the EPS fallback operation in step 1h-35.

The EUTRA frequency measurement results required to perform the EPS fallback are stored in a MeasResultIdleEUTRA IE and transmitted to the base station 1h-10 via a UEInformationResponse message or an RRCResumeComplete message including the IE in step 1h-40.

Upon receiving the message, the base station 1h-10 selects one EUTRA frequency suitable for EPS fallback based on the cell measurement results stored in the message in step 1h-45. The base station 1h-10 may configure, for the UE 1h-05, the operation of inter-RAT HO to the EUTRA frequency in step 1h-50. In this embodiment, in case that the inter-RAT HO is successful according to a predetermined condition (e.g., the predetermine condition corresponds to a condition in which the triggered T304 timer runs at a predetermined configuration value or more), an SHR in which information related to the HO is stored and the stored information is reported to the base station is assumed to be supported. The base station 1h-10 provides the configuration information required to perform the SHR to the UE 1h-05 through a predetermined RRC message.

In order to trigger the inter-RAT HO, the base station 1h-10 transmits a MobilityFromNRCommand message to the UE 1h-05 including the configuration information required to perform the inter-RAT HO. In this case, the message contains a voiceFallbackIndication field.

Upon receiving the message, the UE 1h-05 starts the T304 timer, and when the inter-RAT HO is successfully completed before the timer expires (i.e., random access process to a target cell is considered to be successfully completed), the HO is considered to be successful in step 1h-55. In step 1h-60, if the predetermined condition is satisfied, the UE 1h-05 may store the predetermined information related to the successful HO as the content of the SHR.

When at least one of conditions A and B is satisfied, the information related to the early EPS fallback may be stored in the VarRLF-Report along with the HO failure-related information previously defined.

A—The UE 1h-05 has reported the measurement result of the EUTRA frequencies configured in SIB 5 to a serving base station (or serving cell) that has transmitted the MobilityFromNRCommand through an EMR operation, and the inter-RAT HO triggered by the MobilityFromNRCommand is successful, or

B—The UE 1h-05 has performed an inter-RAT HO to one EUTRA cell among the cells belonging to the EUTRA frequencies configured in SIB 5 having been reported through EMR operation, and the HO has been successful.

The information related to the early EPS fallback include the following.
An indicator indicating whether a UE has reported the measurement results of the EUTRA frequencies configured in SIB 5 to a base station by using EMR.
An indicator indicating whether an idleModeMeasVoiceFallback field is configured in SIB 5 that a serving cell is broadcasting.
An indicator indicating whether a cell belonging to the EUTRA frequencies configured in SIB 5 corresponds to a target cell in the inter-RAT HO.
An indicator indicating whether a cell belonging to the EUTRA frequencies configured in SIB 5 and reported through EMR corresponds to a target cell in the inter-RAT HO.
A list of EUTRA frequencies configured in SIB 5 and reported through EMR and information related to frequencies, i.e., ARFCN information for each frequency, PCI information for cells belonging to each frequency, and RSRP/RSRQ measurement results.
Information about the time taken after a UE transmits an RRCSetupRequest/RRCResumeRequest message (or after receiving an RRCSetup/RRCResume message) for the purpose of obtaining IMS services and until the UE receives a MobilityFromNRCommand message.
Information about the time until the inter-RAT HO is successful after a UE transmits an RRCSetupRequest/RRCResumeRequest message for receiving IMS services.
Information about the time taken after EMR measurement information is reported through a UEInformationResponse message or an RRCResumeComplete message and until a MobilityFromNRCommand message is received.
Information about the time until the inter-RAT HO is successful after reporting EMR measurement information through a UEInformationResponse message or an RRCResumeComplete message.

When the UE 1h-05 is connected to the base station 1h-10, the UE transmits a predetermined RRC message including a predetermined availability indicator to the base station 1h-10. The availability indicator indicates that the SHR contents are being stored.

Upon receiving the indicator, the base station 1h-10 may request the stored SHR by using a UEInformationRequest message. Upon receiving the request, the UE 1h-05 reports a UEInformationResponse message including the SHR to the base station 1h-10.

Upon receiving the SHR, the base station 1h-10 forwards the SHR to other base stations relevant to the information contained in the SHR, or transmits the SHR to a predetermined implementation server, e.g., a SON server. The information may be used to optimize the EPS fallback.

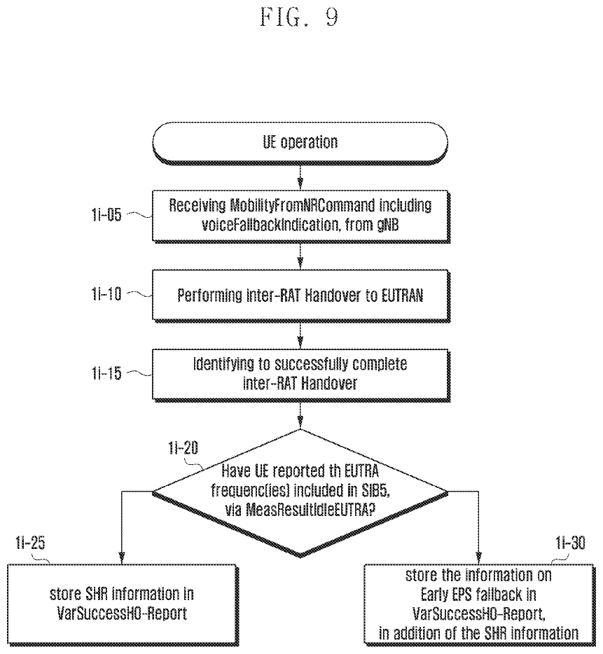

FIG. 9 is a flowchart illustrating a UE operation for storing early EPS fallback-related information as SHR report contents according to an embodiment.

Referring to FIG. 9, in step 1i-05, a UE receives a MobilityFromNRCommand message including a voiceFallbackIndication field from a base station.

In step 1i-10, the UE performs an inter-RAT HO using the inter-RAT HO configuration information in the MobilityFromNRCommand. Here, the T304 timer is driven.

In step 1i-15, the UE considers the inter-RAT HO as being successful if the inter-RAT HO is successfully completed before the T304 timer expires.

In step 1i-20, the UE determines whether EUTRA frequency information stored in SIB 5 has been reported to the base station through the EMR process before performing the inter-RAT HO for EPS fallback, and whether the SHR trigger condition has been satisfied.

In step 1i-25, if the EUTRA frequency information stored in SIB 5 has not reported to the base station through the EMR process, the UE stores previously-defined HO success-related information in VarSuccessHO-Report, which is a UE internal storage variable.

In step 1i-30, if the EUTRA frequency information stored in SIBS has been reported to the base station through the EMR process, the UE stores the new information in accordance with this embodiment, together with the previously-defined HO failure-related information, in the VarSuccessHO-Report, which is the UE internal storage variable.

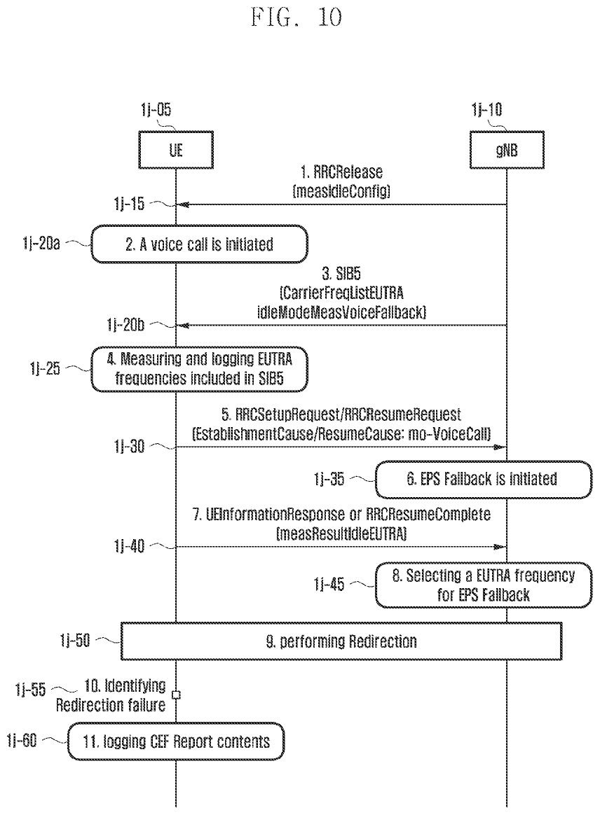

FIG. 10 is a signal flow diagram illustrating a process of storing early EPS fallback-related information as CEF report contents according to an embodiment.

Referring to FIG. 10, a base station 1j-10 transmits an RRCRelease message including a MeasIdleConfigDedicated IE to a UE 1j-05 in step 1j-15. The IE includes information for performing an EMR operation.

Upon receiving the RRCRelease message, the UE 1j-05 switches from a connected mode to a standby or inactive mode, and triggers IMS voice services in step 1j-20a. The UE 1j-05 identifies whether an idleModeMeasVoiceFallback field is included in SIB 5 in step 1j-20b. If the field is included in SIB 5, the UE 1j-05 that triggered IMS voice services may also consider EUTRA frequencies for the purpose of cell reselection, included in SIB 5, as frequencies to be stored through the EMR operation in step 1j-25.

The UE 1j-05 transmits an RRCSetupRequest message or an RRCResumeRequest message including a predetermined cause value, “mo-VoiceCall”, indicating the idleModeMeasVoiceFallback field to the base station 1j-10 in step 1j-30.

Upon receiving the message, the base station 1j-10 may trigger the EPS fallback operation in step 1j-35.

The EUTRA frequency measurement results for performing the EPS fallback are stored in a MeasResultIdleEUTRA IE and transmitted to the base station 1j-10 via a UEInformationResponse message or an RRCResumeComplete message including the IE in step 1j-40.

Upon receiving the message, the base station 1j-10 selects one EUTRA frequency suitable for EPS fallback based on the cell measurement results stored in the message in step 1j-45. In addition, the base station 1j-10 may configure, for the UE 1j-05, the re-direction operation to the EUTRA frequency in step 1j-50. In order to trigger the re-direction, the base station 1j-10 transmits, to the UE 1j-05, an RRCRelease message including the configuration information required to perform the re-direction. The RRCRelease message includes a voiceFallbackIndication.

Upon receiving the above message, the UE 1j-05 performs an establishment operation with a EUTRA cell belonging to the EUTRA frequencies indicated by the RedirectedCarrierInfo-EUTRA IE included in the RRCRelease message. Here, the cnType field of the RedirectedCarrierInfo-EUTRA IE is configured as “epc”. The UE 1j-10 starts the T300 timer, and when the establishment is not successfully completed and the timer expires (i.e., random access process to the target cell is not successfully completed), the establishment operation is considered to have failed (or the re-direction operation is considered to have failed) in step 1j-55. The UE 1j-10 may store predetermined information related to the establishment failure as the content of CEF report in step 1j-60.

If at least one of conditions A and B is satisfied, the information related to the early EPS fallback may be stored in VarConnEstFailReport or VarConnEstFailReportLst along with the information related to establishment failure previously defined.

A—The UE 1j-05 has ever reported the measurement result of the EUTRA frequencies configured in SIB 5 to a serving base station (or serving cell) that has transmitted an RRCRelease message including a voiceFallbackIndication field and the RedirectedCarrierInfo-EUTRA IE through the EMR operation, and the re-direction (i.e., the establishment operation to the EUTRA cell) triggered by the RRCRelease has failed; or

B—The UE 1j-05 has performed a re-direction to one EUTRA cell among the cells belonging to the EUTRA frequencies configured in SIB 5, which has been reported through the EMR operation, and the re-direction has failed.

The early EPS fallback-related information includes the following.
An indicator indicating whether the UE has reported the measurement results of the EUTRA frequencies configured in SIB 5 to the base station by using EMR.
An indicator indicting whether an idleModeMeasVoiceFallback field is configured in SIB that a serving cell is broadcasting.
An indicator indicating whether the EUTRA frequencies configured in SIB 5 correspond to frequencies (eutraFrequency field) indicated by the RedirectedCarrierInfo-EUTRA IE included in the RRCRelease message.
An indicator indicating whether the EUTRA frequencies configured in SIB 5 and reported through the EMR correspond to frequencies (eutraFrequency field) indicated by the RedirectedCarrierInfo-EUTRA IE included in the RRCRelease message.
A list of EUTRA frequencies configured in SIB 5 and reported through the EMR and information related to frequencies, i.e., ARFCN information for each frequency, PCI information for cells belonging to each frequency, and RSRP/RSRQ measurement results.
Information about the time taken after a UE transmits an RRCSetupRequest/RRCResumeRequest message (or after receiving an RRCSetup/RRCResume message) for obtaining IMS services and until the UE receives a MobilityFromNRCommand message.
Information about the time taken after a UE transmits an RRCSetupRequest/RRCResumeRequest message (or after receiving an RRCSetup/RRCResume message) for obtaining IMS services and until the establishment operation triggered by the RRCRelease message including the voiceFallbackIndication field and the RedirectedCarrierInfo-EUTRA IE fails (T300 timer expires).
Information about the time taken after EMR measurement information is reported through a UEInformationResponse message or an RRCResumeComplete message and until an RRCRelease message including the voiceFallbackIndication field and the RedirectedCarrierInfo-EUTRA IE is received.
Information about the time taken after EMR measurement information is reported through a UEInformationResponse message or an RRCResumeComplete message and until the establishment operation triggered by the RRCRelease message including the voiceFallbackIndication field and the RedirectedCarrierInfo-EUTRA IE fails (T300 timer expires).

Thereafter, when the UE 1j-05 is connected to the base station 1j-10, the UE transmits a predetermined RRC message including a predetermined availability indicator to the base station 1j-10. The availability indicator is used to indicate that the CEF report contents are being stored.

Upon receiving the indicator, the base station 1j-10 may request the stored CEF report from the UE 1j-05 by using a UEInformationRequest message. Upon receiving the request, the UE 1j-05 reports a UEInformationResponse message including the CEF report to the base station 1j-10.

Upon receiving the CEF report, the base station 1j-10 forwards the CEF report to other base stations relevant to the information contained in the CEF report, or transmits CEF report to a predetermined implementation server, e.g., a SON server. The information included in the CEF report may be used to optimize the EPS fallback.

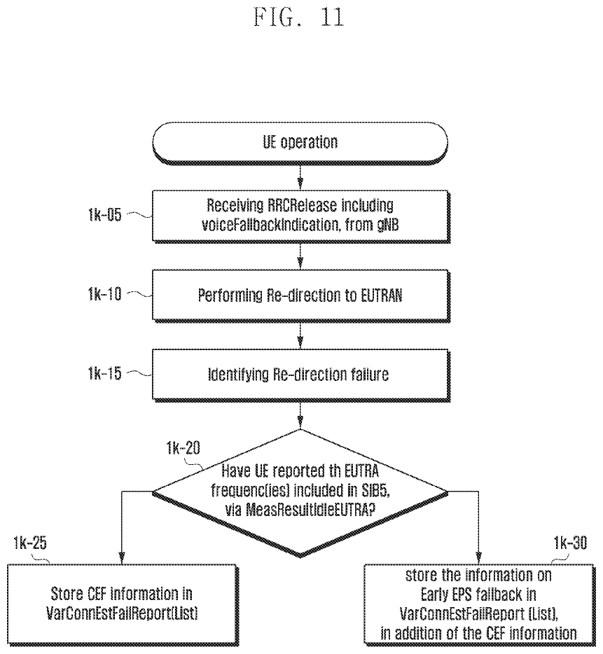

FIG. 11 is a flowchart illustrating a UE operation for storing early EPS fallback-related information as CEF report contents according to an embodiment.

Referring to FIG. 11, in step 1k-05, a UE receives an RRCRelease message including a voiceFallbackIndication field from a base station.

In step 1k-10, the UE performs a re-direction using re-direction configuration information included in the RRCRelease message. The UE performs an establishment operation on one EUTRA cell, and at this time, the T300 timer is driven.

In step 1k-15, the UE considers the re-direction to have failed if the T300 timer expires before the establishment operation has been successfully completed.

In step 1k-20, the UE determines whether EUTRA frequency information stored in SIB 5 has been reported to the base station through EMR process before performing the re-direction for EPS fallback.

In step 1k-25, if the EUTRA frequency information stored in SIB 5 has not reported to the base station through the EMR process, the UE stores previously-defined establishment failure-related information in VarConnEstFailReport or VarConnEstFailReportList, which is a UE internal storage variable.

In step 1k-30, if the EUTRA frequency information stored in SIBS has been reported to the base station through the EMR process, the UE stores the new information in according with this embodiment, together with the previously-defined establishment failure-related information in VarConnEstFailReport or VarConnEstFailReportList, which is a UE internal storage variable.

In accordance with an embodiment of the disclosure, an NR base station may, when the base station does not yet support IMS services or for load balancing, even when the base station supports the IMS, hand over a UE that wants IMS voice services to an EUTRA base station. To this end, the NR base station transmits a MobilityFromNRCommand message including voiceFallbackIndication to the UE.

In case that an inter-RAT HO triggered by the MobilityFromNRCommand message including the voiceFallbackIndication fails, the UE may search and select a suitable EUTRA cell. This is to reduce a time taken to receive voice services, as the voice service is ultimately served by the EUTRA base station.

A UE that identified a suitable EUTRA cell performs an establishment operation to the cell, and if the switching to a connected mode is successful, the UE may receive the voice service in the cell.

If a suitable EUTRA cell is not found, the UE performs re-establishment operation in NR network. For example, in case that it is not an inter-RAT HO triggered by the MobilityFromNRCommand message including the voiceFallbackIndication, the UE performs a re-establishment operation in the NR immediately without searching for a suitable cell in EUTRA when the HO fails.

If the voice service is an emergency service, a UE may be supported with the emergency service in a suitable cell and also in an acceptable cell.

In accordance with an embodiment, when a UE needs to receive an emergency voice service and, when the inter-RAT HO triggered by the MobilityFromNRCommand message including voiceFallbackIndication fails, the UE may to search and select a suitable EUTRA cell or an acceptable cell. When this scenario occurs, the UE collects and reports predetermined information related to the scenario.

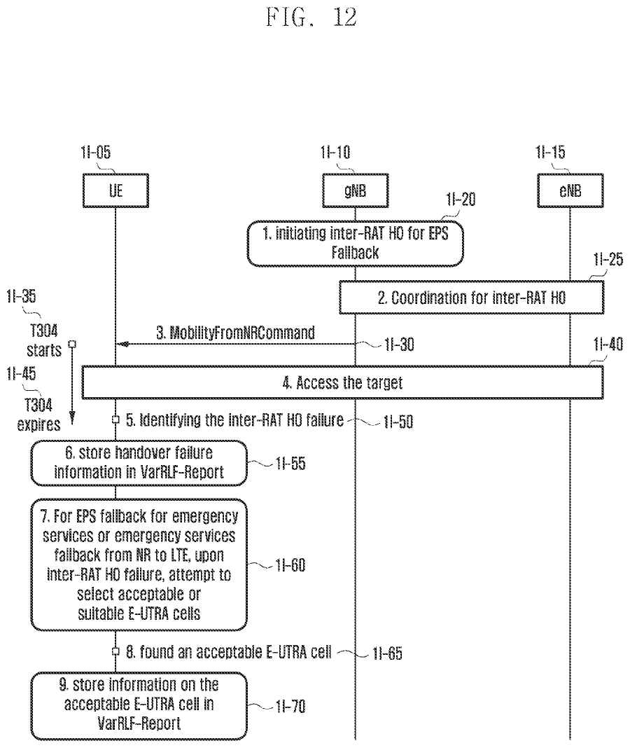

FIG. 12 is a signal flow diagram illustrating a process of storing fallback-related information for emergency services as RLF report contents according to an embodiment.

Referring to FIG. 12, an NR base station 1l-10 triggers an inter-RAT HO for EPS fallback to a UE 1l-05 in step 1l-20. The NR base station 1l-10 exchanges information for the inter-RAT HO with an EUTRA base station 1l-15 in step 1l-25. Here, the NR base station 1l-10 may also transmit an indicator indicating that the UE 1l-05 should be provided with emergency services to the EUTRA base station 1l-15.

The NR base station 1l-10 transmits the MobilityFromNRCommand message including the voiceFallbackIndication to the UE 1l-05 in step 1l-30.

Upon receiving the message, the UE 1l-05 starts a T304 timer in step 1l-35, and performs a random access to a target EUTRA cell indicated by the message in step 1l-40. When the random access is not successfully completed before the T304 timer expires in step 1l-45, the UE 1l-05 considers that the inter-RAT HO has failed in step 1l-50.

The UE 1l-05 stores information related to the HO failure in VarRLF-Report in step 1l-55. When the EPS fallback (i.e., the inter-RAT HO) has been triggered so that the UE 1l-05 can be provided with emergency voice services, the UE 1l-05 may search a suitable EUTRA cell or an acceptable EUTRA cell in step 1l-60. The UE 1l-05 first searches whether there is a suitable EUTRA cell in predetermined frequencies, and if the UE has failed to search one suitable EUTRA cell, the UE searches whether there is an acceptable EUTRA cell in predetermined frequencies as the next best option.

The UE 1l-05 succeeds in finding one acceptable EUTRA cell in step 1l-65. The UE 1l-05 may be provided with the emergency service even in the acceptable cell. The UE 1l-05 may additionally store the following information in the VarRLF-Report.
New indicator to indicate whether to select an acceptable cell when there is no suitable cell for emergency call upon inter-RAT HO failure during EPS fallback.
New indicator to indicate whether to select either suitable cell or acceptable cell (for emergency call) upon inter-RAT HO failure during EPS fallback.
Info of the acceptable cell, i.e., cell global identity (CGI) and/or PCI.
   Measurement results of the suitable or acceptable cell upon finding the suitable/acceptable cell after inter-RAT HO failure.
Measurement results of the neighboring cells upon finding the suitable/acceptable cell after inter-RAT HO failure.
Time until selection of an acceptable cell or suitable cell since inter-RAT HO failure.
   Time until selection of an acceptable cell or suitable cell since the reception of MobilityFromNRCommand for EPS fallback.

When the UE 1l-05 is connected to the base station 1l-10, the UE transmits a predetermined RRC message including a predetermined availability indicator to the base station 1l-10. The availability indicator is used to indicate that the RLF report contents are being stored. The base station 1l-10 may be an NR base station, but does not exclude an EUTRA base station. For example, in the current standard technology, the RLF report can only be reported to an NR base station, but in the future, it may be improved to report the RLF report to an EUTRA base station as well.

Upon receipt of the indicator, the base station 1l-10 may request the stored RLF report by using the UEInformationRequest message. Upon receiving the request, the UE 1l-05 reports a UEInformationResponse message including the RLF report to the base station 1l-10.

Upon receiving the RLF report, the base station 1l-10 forwards the RLF report to other base stations relevant to the information contained in the RLF report, or transmits the RLF report to a predetermined implementation server, e.g., a SON server. The information included in the RLF report may be used to optimize the EPS fallback.

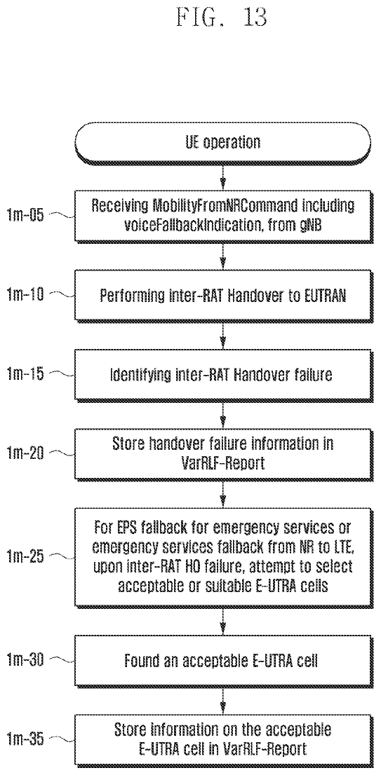

FIG. 13 is a flowchart illustrating a UE operation for storing fallback-related information for emergency services as RLF report contents according to an embodiment.

Referring to FIG. 13, in step 1m-05, a UE requiring emergency voice services receives a MobilityFromNRCommand message including a voiceFallbackIndication field from an NR base station.

In step 1m-10, the UE performs an inter-RAT HO to a target EUTRA cell indicated by configuration information of the MobilityFromNRCommand message.

In step 1m-15, the UE recognizes that the inter-RAT HO has failed.

In step 1m-20, the UE stores information related to the failure of the inter-RAT HO in a VarRLF-Report.

In step 1m-25, the UE determines whether there are acceptable EUTRA cells as well as suitable EUTRA cells, since the UE should be provided with emergency services.

In step 1m-30, the UE succeeds in finding an acceptable EUTRA cell.

In step 1m-35, the UE stores information related to the acceptable EUTRA cell.

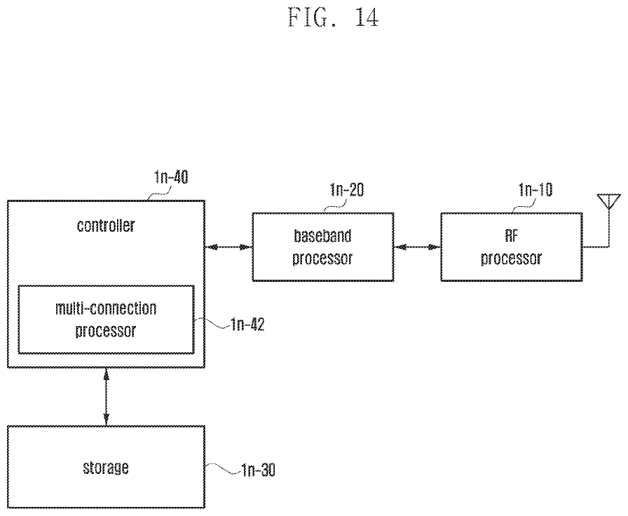

FIG. 14 illustrates a terminal according to an embodiment.

Referring to FIG. 14, the terminal includes a radio frequency (RF) processor 1n-10, a baseband processor 1n-20, a storage 1n-30, and a controller 1n-40.

The RF processor 1n-10 performs functions for transmitting and receiving signals via a wireless channel, such as band conversion and amplification of signals. That is, the RF processor 1n-10 up-converts a baseband signal provided by the baseband processor 1n-20 into an RF band signal and then transmits the RF band signal via an antenna, and down-converts an RF band signal received via the antenna into a baseband signal. For example, the RF processor 1n-10 may include a transmission filter, a reception filter, an amplifier, a mixer, an oscillator, a digital to analog converter (DAC), an analog to digital converter (ADC), etc.

Although only one antenna is illustrated in FIG. 14, the terminal may include multiple antennas. Further, the RF processor 1n-10 may include multiple RF chains. Furthermore, the RF processor 1n-10 may perform beamforming. For the beamforming, the RF processor 1n-10 may adjust the phase and magnitude of each of the signals transmitted and received through the multiple antennas or antenna elements. Further, the RF processor 1n-10 may perform MIMO, and may receive multiple layers when performing MIMO operation.

The baseband processors 1n-20 perform conversion functions between baseband signals and bitstreams according to the physical layer specifications of the system. For example, when transmitting data, the baseband processor 1n-20 generates complex symbols by encoding and modulating transmission bitstreams.

Upon receiving data, the baseband processor 1n-20 demodulates and decodes the baseband signal provided from the RF processor 1n-10 to restore the received bitstream. For example, when the data is transmitted according to an OFDM scheme, the baseband processor 1n-20 generates the complex symbols by encoding and modulating the transmission bitstreams and maps the complex symbols to subcarriers and then configures OFDM symbols through an inverse fast Fourier transform (IFFT) operation and cyclic prefix (CP) insertion.

Upon receiving data, the baseband processor 1n-20 divides the baseband signal provided from the RF processor 1n-10 into OFDM symbol units and restores the signals mapped to the subcarriers through a fast Fourier transform (FFT) operation and then restores the received bitstreams through demodulation and decoding.

The baseband processor 1n-20 and the RF processor 1n-10 transmit and receive signals as described above. Accordingly, the baseband processor 1n-20 and the RF processor 1n-10 may be referred to as a transmitter, a receiver, a transceiver, or a communication unit. Further, at least one of the baseband processor 1n-20 and the RF processor 1n-10 may include multiple communication modules in order to support multiple different radio access technologies. In addition, at least one of the baseband processor 1n-20 and the RF processor 1n-10 may include different communication modules in order to process signals of different frequency bands. For example, the different radio access technologies may include a wireless local area network (LAN) (e.g., IEEE 802.11), a cellular network (e.g., LTE), etc. In addition, the different frequency bands may include a super high frequency (SHF) (e.g., 2 NRHz or NRhz) band and a millimeter wave (e.g., 60 GHz) band.

The storage 1n-30 stores data such as a basic program, an application program, and configuration information for the operation of the terminal. In particular, the storage 1n-30 may store information related to a second access node for performing wireless communication using a second RAT. In addition, the storage 1n-30 provides the stored data according to a request of the controller 1n-40.

The controller 1n-40 controls overall operations of the terminal. For example, the controller 1n-40 transmits and receives the signals through the baseband processor 1n-20 and the RF processor 1n-10. In addition, the controller 1n-40 writes and reads the data to and from the storage 1n-30. To this end, the controller 1n-40 may include at least one processor, e.g., a multi-connection processor 1n-42. For example, the controller 1n-40 may include a communication processor for performing a control for communication and an application processor (AP) for controlling a higher layer such as an application program.

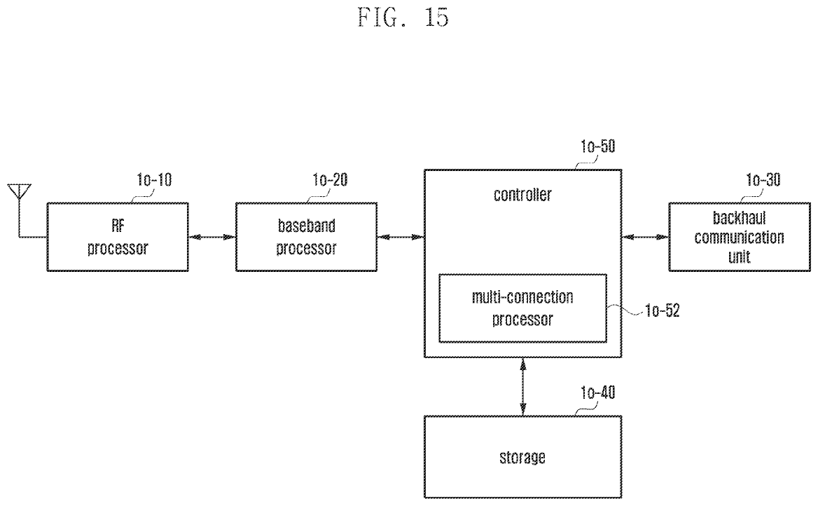

FIG. 15 illustrates a base station according to an embodiment.

Referring to FIG. 15, the base station includes an RF processor 1o-10, a baseband processor 1o-20, a backhaul communication unit 1o-30, a storage 1o-40, and a controller 1o-50.

The RF processor 1o-10 performs functions for transmitting and receiving signals via a wireless channel, such as band conversion and amplification of signals. That is, the RF processor 1o-10 upconverts a baseband signal provided by the baseband processor 1o-20 into an RF band signal and then transmits the RF band signal via an antenna, and downconverts an RF band signal received via the antenna into a baseband signal. For example, the RF processors 1o-10 may include a transmission filter, a reception filter, an amplifier, a mixer, an oscillator, a DAC, an ADC, etc.

Although only one antenna is illustrated in FIG. 15, the base station may include multiple antennas. Further, the RF processors 1o-10 may include multiple RF chains. Furthermore, the RF processor 1o-10 may perform beamforming. For the beamforming, the RF processor 1o-10 may adjust the phase and magnitude of each of the signals transmitted and received through the multiple antennas or antenna elements. The RF processor 1o-10 may perform a downlink MIMO operation by transmitting one or more layers.

The baseband processor 1o-20 performs the conversion function between the baseband signal and the bitstream according to the physical layer specification of the system. For example, at the time of data transmission, the baseband processor 1o-20 generates the complex symbols by encoding and modulating the transmission bitstreams.

Upon receiving data, the baseband processor 1o-20 demodulates and decodes the baseband signal provided from the RF processor 1o-10 to restore the received bitstream. For example, when the data is transmitted according to the OFDM scheme, the baseband processor 1o-20 generates the complex symbols by encoding and modulating the transmission bitstreams and maps the complex symbols to the subcarriers, and then configures the OFDM symbols through the IFFT operation and the CP insertion.

Upon receiving data, the baseband processor 1o-20 divides the baseband signal provided from the RF processor 1o-10 into the OFDM symbol units and restores the signals mapped to the subcarriers through the FFT operation and then restores the received bitstreams through the demodulation and decoding. The baseband processor 1o-20 and the RF processor 1o-10 transmit and receive the signals as described above. As a result, the baseband processor 1o-20 and the RF processor 1o-10 may be referred to as the transmitter, the receiver, the transceiver, the communication unit, or a wireless communication unit.

The backhaul communication unit 1o-30 provides an interface for performing communication with other nodes in a network. That is, the backhaul communication unit 1o-30 converts bitstreams transmitted from the main base station to other nodes, for example, a sub-base station, a CN, etc., into a physical signal and converts the physical signal received from the other node into the bitstream.

The storage 1o-40 stores the data such as a basic program, an application program, and configuration information for the operation of the main base station. In particular, the storage 1o-40 may store information on a bearer allocated to the connected terminal, measurement results reported from the connected terminal, etc. The storage 1o-40 may store information serving as a criterion for determining whether to provide multiple connections to the terminal or whether to suspend the multiple connections. Further, the storage 1o-40 provides the stored data according to the request of the controller 1o-50.

The controller 1o-50 controls the overall operations of the main base station. For example, the controller 1o-50 transmits and receives the signals through the baseband processor 1o-20 and the RF processor 1o-10 or the backhaul communication unit 1o-30. In addition, the controller 1o-50 writes and reads the data to and from the storage 1o-40. To this end, the controller 1o-50 may include at least one processor, e.g., a multi-connection processor 1o-52.

In the above-described detailed embodiments of the disclosure, although an element included in the disclosure is expressed in the singular or the plural according to presented detailed embodiments, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments, but should be defined by the appended claims and equivalents thereof

What is claimed is:

1. A method performed by a terminal in a wireless communication system, the method comprising:
receiving, from a base station of a first radio access technology (RAT), a message to command an inter-RAT handover (HO), the message including information indicating that the inter-RAT HO is triggered by evolved packet system (EPS) fallback for Internet protocol (IP) multimedia subsystem (IMS) voice;
performing the inter-RAT HO based on the message;
based on a failure of the inter-RAT HO, identifying whether there is a suitable cell of a second RAT for selection;
in case that there is no suitable cell of the second RAT, selecting an acceptable cell of the second RAT based on the IMS voice being for an emergency service; and
logging a time until the terminal accesses the acceptable cell of the second RAT.

2. The method of claim 1, wherein the time is logged between the failure of the inter-RAT HO and the access to the acceptable cell of the second RAT.

3. The method of claim 1, wherein the time is logged between a reception of the message and the access to the acceptable cell of the second RAT.

4. The method of claim 1, further comprising transmitting, to the base station, a report including information on the logged time, in case that a connection between the terminal and the base station is re-established.

5. The method of claim 4, further comprising:
transmitting, to the base station, a radio resource control (RRC) message including an indicator indicating availability of the report, based on re-establishment of the connection between the terminal and the base station; and
receiving, from the base station, a user equipment (UE) information request message requesting the report based on the RRC message,
wherein the report is transmitted via a UE information response message based on the UE information request message.

6. The method of claim 1, further comprising:
determining to initiate a voice call for the IMS voice, while the terminal is in a radio resource control (RRC) idle state or an RRC inactive state; and
transmitting, to the base station, a request message for an RRC connection including information on a cause set to the voice call,
wherein the message is received after the request message is transmitted.

7. The method of claim 6, further comprising:
receiving, from the base station, system information including information on at least one carrier frequency of the second RAT and information indicating that a measurement and a reporting for the EPS fallback are used; and
performing a measurement for the at least one carrier frequency of the second RAT while the terminal is in the RRC idle state or the RRC inactive state, based on the system information,
wherein a result of the measurement is reported to the base station after the terminal transitions to an RRC connected state based on the request message.

8. The method of claim 7, wherein the message is received based on the result for the measurement.

9. The method of claim 6, wherein the suitable cell is searched for the at least one carrier frequency of the second RAT.

10. A terminal in a wireless communication system, the terminal comprising:
a transceiver; and
a controller configured to:
control the transceiver to receive, from a base station of a first radio access technology (RAT), a message to command an inter-RAT handover (HO), the message including information indicating that the inter-RAT HO is triggered by evolved packet system (EPS) fallback for Internet protocol (IP) multimedia subsystem (IMS) voice,
perform the inter-RAT HO based on the message,
based on a failure of the inter-RAT HO, identify whether there is a suitable cell of a second RAT for selection,
in case that there is no suitable cell of the second RAT, select an acceptable cell of the second RAT based on the IMS voice being for an emergency service, and
log a time until the terminal accesses the acceptable cell of the second RAT.

11. The terminal of claim 10, wherein the time is logged between the failure of the inter-RAT HO and the access to the acceptable cell of the second RAT.

12. The terminal of claim 10, wherein the time is logged between a reception of the message and the access to the acceptable cell of the second RAT.

13. The terminal of claim 10, wherein the controller is further configured to control the transceiver to transmit, to the base station, a report including information on the logged time, in case that a connection between the terminal and the base station is re-established.

14. The terminal of claim 13, wherein the controller is further configured to:
control the transceiver to transmit, to the base station, a radio resource control (RRC) message including an indicator indicating availability of the report, based on re-establishment of the connection between the terminal and the base station, and
control the transceiver to receive, from the base station, a user equipment (UE) information request message requesting the report based on the RRC message, and
wherein the report is transmitted via a UE information response message based on the UE information request message.

15. The terminal of claim 10, wherein the controller is further configured to:
determine to initiate a voice call for the IMS voice, while the terminal is in a radio resource control (RRC) idle state or an RRC inactive state, and
control the transceiver to transmit, to the base station, a request message for an RRC connection including information on a cause set to the voice call, and wherein the message is received after the request message is transmitted.

16. The terminal of claim 15, wherein the controller is further configured to:
control the transceiver to receive, from the base station, system information including information on at least one carrier frequency of the second RAT and information indicating that a measurement and a reporting for the EPS fallback are used, and
perform a measurement for the at least one carrier frequency of the second RAT while the terminal is in the RRC idle state or the RRC inactive state, based on the system information, and
wherein a result of the measurement is reported to the base station after the terminal transitions to an RRC connected state based on the request message.

17. The terminal of claim 16, wherein the message is received based on the result for the measurement.

18. The terminal of claim 15, wherein the controller is further configured to search the suitable cell for the at least one carrier frequency of the second RAT.
